(19) United States
(12) Patent Application Publication
(10) Pub. No.: US 2011/0036701 A1
(43) Pub. Date: Feb. 17, 2011

(54) CLOSED-AIR CUSHIONED KEY SWITCH STRUCTURE

(76) Inventor: Yung-Hui WANG, Taipei City (TW)

Correspondence Address: Muncy, Geissler, Olds & Lowe, PLLC, 4000 Legato Road, Suite 310, FAIRFAX, VA, 22033, US

(21) Appl. No.: 12/845,186

(22) Filed: Jul. 28, 2010

(30) Foreign Application Priority Data
Aug. 17, 2009 (TW) 098127621

(51) Int. Cl. H01H 3/02

(52) U.S. Cl. 200/512

(57) ABSTRACT

A closed-air cushioned key switch structure includes an electrical board having multiple contacts, and multiple key switch bodies arranged above the contacts of the electrical board, each key switch body having top press portion for clicking by a user, a conductor at the bottom side for contacting one respective contact of the electrical board to produce a switching signal and an enclosed air chamber defined in between the press portion and the conductor for buffering clicking to give comfort to the user's finger to avoid noises. The key switch bodies are formed in integrity without any gap in therebetween, avoiding penetration of fluid or water through the key switch bodies to contaminate or wet the electrical board.

This application claims the priority benefit of Taiwan patent application number 098127621, filed on Aug. 17, 2009.

### BACKGROUND OF THE INVENTION

1. Field of the Invention

The present invention relates to key switches and more particularly, to a closed-air cushioned key switch structure, which has an enclosed air chamber defined in each key switch body to provide an elastic buffer effect, giving comfort to the user's finger and avoiding production of clicking noises. The key switch bodies are formed in integrity, avoiding penetration of fluid or water to contaminate or wet the electrical board.

2. Description of the Related Art

Following fast development of technology, versatile and advanced electrical and electronic products have been continuously created and have appeared on the market. These versatile and advanced electrical and electronic products provide better comfort to our life and help improving our working efficiency. Nowadays, desk computer, notebook computer, cell phone, PDA, language translator, electronic dictionary, remote controller, digital camera, digital video camera and many other digital electronic products are intensively used by people everywhere. These electrical and electronic products commonly have key switches for operation control and/or data entry. These key switches commonly comprise a key cap made of a hard material, and an elastic support member, for example, rubber cone for supporting the key cap for automatic reset. Further, key switches are individually installed in a keyboard frame. After installation, key switches are kept apart from one another by a gap. This key switch mounting arrangement has drawbacks as follows:
1. Because the key cap of each key switch is prepared from a hard material and installed with the respective elastic support member in the keyboard frame, clicking the key switches will produce noises to disturb other people.
2. The hard material of the key caps of the key switches cannot give comfort to the user's fingers. The user will suffer finger pain soon when work long.
3. The key switches in a keyboard are spaced from one another by a gap. If the user spilled fluid, water or beverage accidentally, the fluid, water or beverage may penetrate through the gap in between each two adjacent key switches to contaminate or wet the circuit board at the bottom side of the key switches, causing damage. Cleaning of the contaminated or wetted circuit board takes much time and labor.

Therefore, it is desirable to provide a key switch structure, which eliminates the drawbacks of the prior art designs.

### SUMMARY OF THE INVENTION

The main object of the present invention is to provide an enclosed-air cushioned key switch structure comprising an electrical board and at least one, for example, multiple key switch bodies, wherein each key switch body has an enclosed air chamber defined therein above one respective contact of an electrical board so that when one key switch body is clicked by a user to force the bottom conductor thereof into contact with one respective contact at the electrical board in producing a corresponding switching signal, the enclosed air chamber provides an elastic buffer effect, eliminating the production of any noises.

Further, the enclosed air chamber of each key switch body is filled up with a suitable amount of air. Subject to the elastic buffer effect of the enclosed air chamber, the key switch body gives comfort to the user's finger, avoiding accidental hurt.

Further, the multiple key switch bodies can be formed of a top cover layer and a bottom packaging layer. The top cover layer is configured to provide multiple keycaps. The multiple integrated keycaps of the top cover layer are bonded to the bottom packaging layer to form multiple key switch bodies, therefore no gap is left in between each two adjacent key switch bodies, avoiding penetration of fluid or water through the key switch bodies to contaminate or wet the electrical board.

Further, the closed-air cushioned key switch structure can be configured to constitute a keyboard for use in a desk computer, notebook computer, PDA, language translator, electronic dictionary, telephone, cell phone, intercom or remote controller.

Further, the key switch bodies and the electrical board are fixedly mounted in an electrically insulative frame and covered with a cover shell that has apertures for the passing of the press portions (keycaps) of the key switch bodies for clicking by a user. The electrically insulative frame isolates the electrical board from the outside space.

### BRIEF DESCRIPTION OF THE DRAWINGS

FIG. 1 is an elevational view of a closed-air cushioned key switch structure in accordance with the present invention.

FIG. 2 is an exploded view of the closed-air cushioned key switch structure in accordance with the present invention.

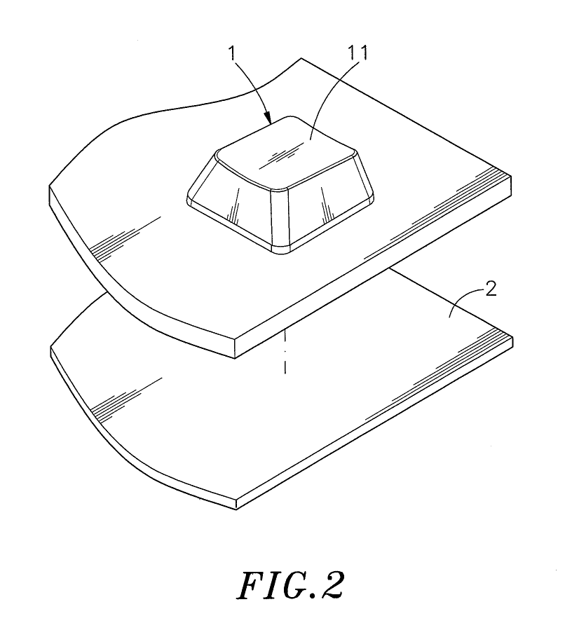

FIG. 3 is a sectional view of the closed-air cushioned key switch structure in accordance with the present invention.

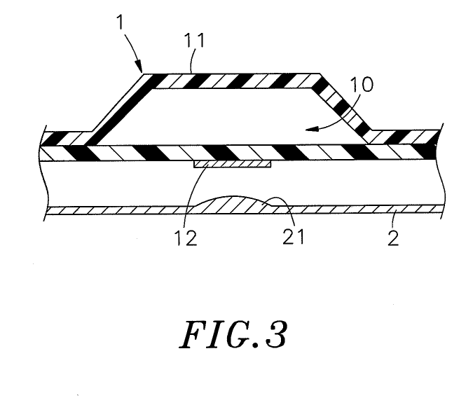

FIG. 4 corresponds to FIG. 3, showing the key switch body clicked, the conductor of the key switch body forced into contact with the corresponding contact at the electrical board.

FIG. 5 is an exploded view of a keyboard based on the closed-air cushioned key switch structure in accordance with the present invention.

FIG. 6 is a sectional view of the present invention, showing two key switch bodies clicked, the conductors of the two key switch bodies forced into contact with the corresponding contacts at the electrical board.

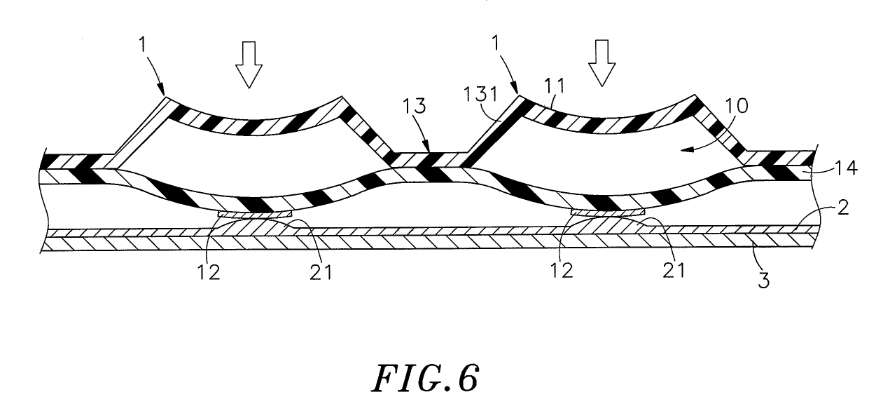

FIG. 7 is a perspective view of an alternate form of the closed-air cushioned key switch structure in accordance with the present invention.

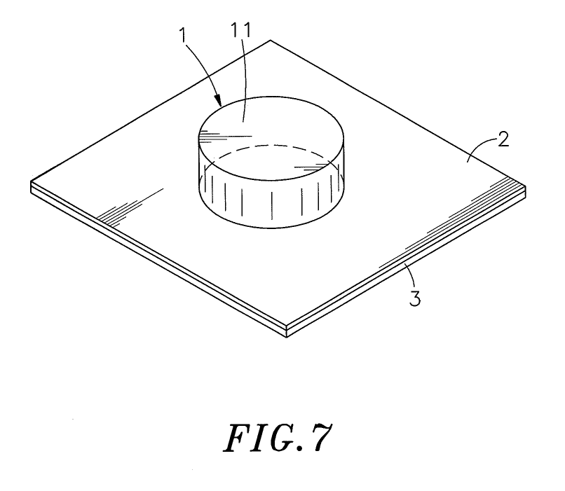

### DETAILED DESCRIPTION OF THE PREFERRED EMBODIMENT

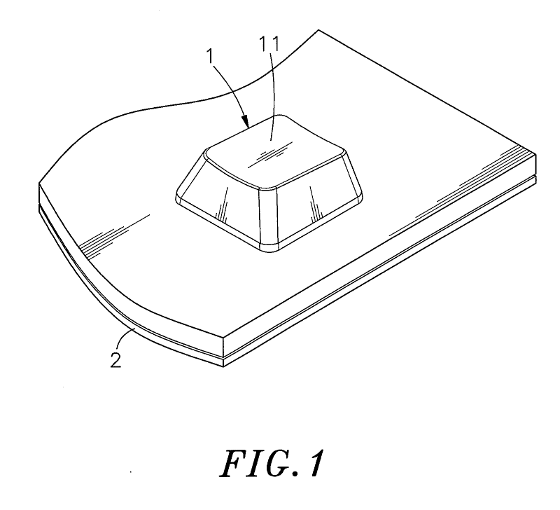

Referring to FIGS. 1˜4, a closed-air cushioned key switch structure in accordance with the present invention is shown comprising at least one key switch body 1 and an electrical board 2.

Each key switch body 1 comprises an enclosed air chamber 10, a press portion 11 formed of the top wall of the enclosed air chamber 10 for clicking by a user, and a conductor 12 located on the bottom surface of the bottom wall of the enclosed air chamber 10.

The electrical board 2 is a thin sheet member, having a circuit layout arranged thereon and at least one contact 21 located on the circuit layout at selected location(s).

The at least one key switch body 1 is arranged above the electrical board 2 to keep the conductor 12 of each key switch body 1 spaced above one respective contact 21 of the electrical board 2 at a predetermined distance.

When a user clicks the press portion 11 of one key switch body 1, the enclosed air chamber 10 is compressed to force the respective conductor 12 downwardly into contact with the corresponding contact 21 of the electrical board 2, causing the circuit layout of the electrical board 2 to output a corresponding switching signal.

Further, the enclosed air chamber 10 of each key switch body 1 is filled up with a proper amount of air. Further, the at least one key switch body 1 is prepared from an electrically insulative elastic material, such as rubber or silicon rubber, giving comfort to the user's fingers. Further, when a user clicks the press portion 11 of one key switch body 1, the enclosed air chamber 10 of the key switch body 1 is compressed. After removal of the user's finger from the press portion 11, the key switch body 1 is returned to its former shape subject to the air cushion effect of the air in the enclosed air chamber 10 of the key switch body 1, avoiding finger pain. Further, the thin sheet electrical board 2 can be a membrane circuit board, thin sheet bus line, flexible PC board, flexible bus line, metal sheet member, mylar flexible board.

Further, each contact 21 of the electrical board 2 can be a piezoelectric element, metal conductor or metal contact element for the contact of the conductor 12 of one key switch body 1 to produce a switching signal.

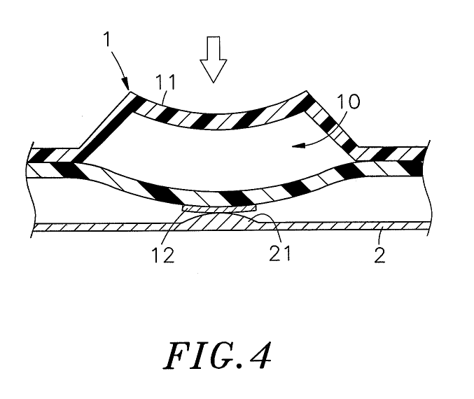

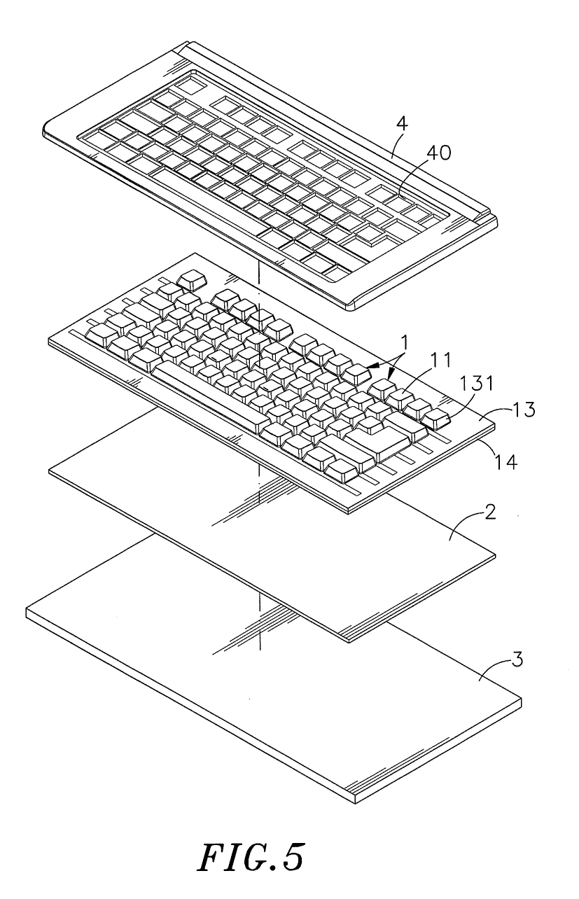

Referring to FIGS. 5˜7 and FIG. 4 again, the at least one key switch body 1 is formed of a top cover layer 13 and a bottom packaging layer 14. The top cover layer 13 is configured to provide at least one, for example, multiple keycaps 131. The bottom packaging layer 14 is bonded to the bottom side of the top cover layer 13 such that an enclosed air chamber 10 is formed in between the top cover layer 13 and the bottom packaging layer 14 corresponding to each keycap 131. Further, a conductor 12 is bonded to the bottom side of the bottom packaging layer 14 corresponding to each enclosed air chamber 10. Further, the top cover layer 13 and the bottom packaging layer 14 can be bonded together by a high-frequency thermal fusion or reflow sealing technique, or by an adhesive. Thereafter, the combination structure of the bottom packaging layer 14, the bonded top cover layer 13 and the conductors 12 is installed with the electrical board 2 in a panel frame 3.

As stated above, the top cover layer 13 can be configured to provide multiple integrated keycaps 131. Thus, the multiple integrated keycaps 131 can be bonded to the bottom packaging layer 14 conveniently and accurately.

Because the invention enables multiple integrated keycaps 131 of the top cover layer 13 to be bonded to the bottom packaging layer 14 to form multiple key switch bodies 1, no gap is left in between each two adjacent key switch bodies 1, avoiding penetration of fluid or water through the key switch bodies 1 to contaminate or wet the electrical board 2.

Further, the at least one key switch body 1 and the electrical board 2 can be mounted in an electrically insulative panel frame 3 in such a manner that the electrical board 2 is kept in between the at least one key switch body 1 and the electrical board 2 and isolated from the outside space; the keycaps 131 of the top cover layer 13 is exposed to the outside for operation by a user.

As stated above, the top cover layer 13 can be configured to provide multiple integrated keycaps 131, i.e., one single piece of the top cover layer 13 and one single piece of the bottom packaging layer 14 can be bonded together to form a set of multiple key switch bodies 1 for making a keyboard for desk computer, notebook computer, PDA, language translator, electronic dictionary, telephone, cell phone, intercom or remote controller. Further, a cover shell 4 may be covered on the top cover layer 13 of the at least one key switch body 1 for protection. As illustrated in FIG. 5, the cover shell 4 has apertures 40 through which the keycaps 131 protrude over the top side of the cover shell 4 for clicking. Further, the keycaps 131 can be made in a square, rectangular, rhombic, polygonal or circular shape, subject to the design of the electric, electronic or digital product that uses the closed-air cushioned key switch structure.

The above embodiment is simply an example of the present invention but not to be used as a limitation. The closed-air cushioned key switch structure comprises at least one key switch body 1, an electrically insulative panel frame 3 holding the at least one key switch body 1 and an electrical board 2 supported on the electrically insulative panel frame 3 and kept spaced above the electrical board 2, wherein each key switch body 1 comprises an enclosed air chamber 10 filled up with a certain amount of air, a press portion 11 formed of the top wall of the enclosed air chamber 10 for clicking by a user, and a conductor 12 located on the bottom surface of the bottom wall of the enclosed air chamber 10 corresponding to one respective contact 21 at the electrical board 2. When a user clicks the press portion 11 of one key switch body 1 to force the associating conductor 12 into contact with the respective contact 21 of the electrical board 2, the enclosed air chamber 10 provides an elastic buffer effect, giving comfort to the user's finger and eliminating the production of any noises. In one embodiment of the present invention, the closed-air cushioned key switch structure comprises multiple key switch bodies 1 each carrying one respective conductor 12 at the bottom side, an electrical board 2 and an electrically insulative panel frame 3, wherein the multiple key switch bodies 1 are formed of a top cover layer 13 and a bottom packaging layer 14; the top cover layer 13 is configured to provide multiple keycaps 131; the bottom packaging layer 14 is bonded to the bottom side of the top cover layer 13 in such a manner that an enclosed air chamber 10 is formed in between the top cover layer 13 and the bottom packaging layer 14 corresponding to each keycap 131. Because the multiple integrated keycaps 131 of the top cover layer 13 are bonded to the bottom packaging layer 14 to form multiple key switch bodies 1, no gap is left in between each two adjacent key switch bodies 1, avoiding penetration of fluid or water through the key switch bodies 1 to contaminate or wet the electrical board 2.

In conclusion, the invention provides a closed-air cushioned key switch structure, which has the following features and advantages:
1. Each key switch body 1 has an enclosed air chamber 10 defined therein and filled up with a certain amount of air. The enclosed air chamber 10 provides an elastic buffer effect upon clicking by a user, eliminating the production of any noises.
2. Subject to the elastic buffer effect of the enclosed air chamber 10 upon clicking by a user, the key switch body 1 gives comfort to the user's finger, avoiding accidental hurt.
3. Multiple key switch bodies 1 can be formed of a top cover layer 13 and a bottom packaging layer 14, wherein the top cover layer 13 is configured to provide multiple keycaps 131. Because the multiple integrated keycaps 131 of the top cover layer 13 are bonded to the bottom packaging layer 14 to form multiple key switch bodies 1, no gap is left in between each two adjacent key switch bodies 1, avoiding penetration of fluid or water through the key switch bodies 1 to contaminate or wet the electrical board 2.

Although particular embodiments of the invention have been described in detail for purposes of illustration, various modifications and enhancements may be made without departing from the spirit and scope of the invention. Accordingly, the invention is not to be limited except as by the appended claims.

1. A closed-air cushioned key switch structure, comprising:
an electrical board, said electrical board comprising a circuit layout arranged thereon and at least one contact located on said circuit layout; and
at least one key switch body arranged above said electrical board, each said key switch body comprising an enclosed air chamber, a press portion formed of a top wall of said enclosed air chamber for clicking by a user, and a conductor located on a bottom side of a bottom wall of said enclosed air chamber and adapted for contacting one said contact of said electrical board to produce a switching signal when a user clicks the press portion of one said key switch body.

2. The closed-air cushioned key switch structure as claimed in claim 1, wherein said at least one key switch body is prepared from an elastic material selected from a group consisting of rubber and silicon rubber.

3. The closed-air cushioned key switch structure as claimed in claim 1, wherein said electrical board is selected from a group consisting of membrane circuit board, thin sheet bus line, flexible PC board, flexible bus line, metal sheet member and mylar flexible board.

4. The closed-air cushioned key switch structure as claimed in claim 1, further comprising a panel frame adapted to carry said electrical board and said at least one key switch body and to isolate said electrical board from the outside space.

5. The closed-air cushioned key switch structure as claimed in claim 4, wherein said electrical board and said at least one key switch body are fixedly fastened to said panel frame; said panel frame is prepared from an electrically insulative material.

6. A closed-air cushioned key switch structure, comprising:
an electrically insulative panel frame;
an electrical board fixedly mounted inside said electrically insulative panel frame, said electrical board comprising a circuit layout arranged thereon and at least one contact located on said circuit layout;
at least one key switch body arranged above said electrical board, each said key switch body comprising an enclosed air chamber, a press portion formed of a top wall of said enclosed air chamber for clicking by a user, and a conductor located on a bottom side of a bottom wall of said enclosed air chamber and adapted for contacting one said contact of said electrical board to produce a switching signal when a user clicks the press portion of one said key switch body; and
a cover shell fastened to said electrically insulative panel frame and covered over said at least one key switch body, said cover shell comprising at least one aperture for enabling the passing of the press portion of each said key switch body.

7. The closed-air cushioned key switch structure as claimed in claim 6, wherein said at least one key switch body is formed of a top cover layer and a bottom packaging layer and having the respective conductor located on a bottom side of said bottom packaging layer, said top cover layer being configured to provide at least one keycap forming the press portion of each said key switch body, said bottom packaging layer being bonded to a bottom side of said top cover layer by a high frequency thermal fusion or reflow sealing technique, or by an adhesive, in such a manner that an enclosed air chamber is formed in between said top cover layer and said bottom packaging layer corresponding to each said keycap.

8. The closed-air cushioned key switch structure as claimed in claim 6, wherein said at least one key switch body is formed of a top cover layer and a bottom packaging layer and having the respective conductor located on a bottom side of said bottom packaging layer, said top cover layer being formed integral with said bottom packaging layer and configured to provide at least one keycap that forms the press portion of each said key switch body.

9. The closed-air cushioned key switch structure as claimed in claim 8, which constitutes a keyboard for use in a desk computer, notebook computer, PDA, language translator, electronic dictionary, telephone, cell phone, intercom or remote controller.
